(19) United States
(12) Patent Application Publication
(10) Pub. No.: US 2024/0312195 A1
(43) Pub. Date: Sep. 19, 2024

(54) INFERRING DEVICE, INFERRING METHOD, AND INFERRING PROGRAM

(71) Applicant: NIPPON TELEGRAPH AND TELEPHONE CORPORATION, Tokyo (JP)

(72) Inventors: Toshiaki WAKATSUKI, Musashino-shi, Tokyo (JP); Sekitoshi KANAI, Musashino-shi, Tokyo (JP); Yasuhiro FUJIWARA, Musashino-shi, Tokyo (JP)

(73) Assignee: NIPPON TELEGRAPH AND TELEPHONE CORPORATION, Tokyo (JP)

(21) Appl. No.: 18/280,675

(22) PCT Filed: Mar. 24, 2021
(86) PCT No.: PCT/JP2021/012406

§ 371 Date: Sep. 7, 2023

(51) Int. Cl. G06V 10/82; G06V 10/70

(52) U.S. Cl. CPC G06V 10/82; G06V 10/87

(57) ABSTRACT

An upper boundary calculation unit calculates an upper boundary of an output value of each layer by using a current input value of each layer and an input value and an output value one time ago in a case where a plurality of layers forming a CNN model sequentially convert frames of a video input in time series by using an activation function; An inactivity selection unit uses the upper boundary to select an inactive portion that does not change according to an input from among outputs of activation functions of the respective layers. A calculation unit calculates an approximate value of an output value of the CNN model by using the upper boundary, the inactive portion, and a portion of the activation function excluding a portion corresponding to the inactive portion.

### TECHNICAL FIELD

The present invention relates to an inference device, an inference method, and an inference program.

### BACKGROUND ART

Conventionally, there are image recognition and object detection technologies using a deep learning model based on convolutional neural networks (CNN). A deep learning model based on CNN is widely used because convolution layers are stacked and high accuracy is exhibited in image recognition and object detection. On the other hand, the calculation cost is high, and in particular, in a case of targeting a video, utilization may be restricted.

Therefore, a technique for reducing the calculation cost in a case where an inference process using CNN is continuously performed has been proposed (refer to Non Patent Literature 1). In this technique, when the inference process using the CNN is continuously performed with each frame of a video as an input, only a part of output values of the convolution layer is updated, so that the calculation cost is reduced.

### CITATION LIST

### Non Patent Literature

Non Patent Literature 1: L. Cavigelli and L. Benini, “CBinfer: Exploiting Frame-to-Frame Locality for Faster Convolutional Network Inference on Video Streams”, IEEE Transactions on Circuits and Systems for Video Technology, vol. 30, no.5, pp. 1451-1465, [online], March 2020, [retrieved on Mar. 4, 2021], Internet <URL: https://arxiv.org/pdf/1808.05488.pdf>

### SUMMARY OF INVENTION

### Technical Problem

However, the conventional technique has a problem that the accuracy of an inference process using CNN deteriorates. That is, as an output value of the convolution layer that is not updated, an output value one time ago is used as it is, and thus a change in the input is ignored and calculation is not performed. Therefore, unlike the original inference process in which all output values are updated, the accuracy may decrease.

The present invention has been made in view of the circumstances, and an object thereof is to suppress deterioration in the accuracy and reduce a calculation cost in an inference process using a deep learning model based on CNN.

### Solution to Problem

In order to solve the above-described problems and achieve the object, according to the present invention, there is provided an inference device including an upper boundary calculation unit that calculates an upper boundary of an output value of each layer by using a current input value of each layer and an input value and an output value one time ago in a case where a plurality of layers forming a model sequentially convert frames of a video input in time series by using an activation function; an inactivity selection unit that uses the upper boundary to select an inactive portion that does not change according to an input from among outputs of activation functions of the respective layers; and a calculation unit that calculates an approximate value of an output value of the model by using the upper boundary, the inactive portion, and a portion of the activation function excluding a portion corresponding to the inactive portion.

### Advantageous Effects of Invention

According to the present invention, it is possible to suppress deterioration in the accuracy and reduce a calculation cost in an inference process using a deep learning model based on CNN.

### BRIEF DESCRIPTION OF DRAWINGS

FIG. 1 is a diagram for describing an outline of an inference device.

FIG. 2 is a diagram for describing an outline of the inference device.

FIG. 3 is a diagram for describing an outline of the inference device.

FIG. 4 is a schematic diagram exemplifying a schematic configuration of the inference device.

FIG. 5 is a diagram for describing processes of an upper boundary calculation unit and an inactivity selection unit.

FIG. 6 is a diagram for describing processing of a calculation unit.

FIG. 7 is a flowchart illustrating an inference process procedure.

FIG. 8 is a diagram for describing an example.

FIG. 9 is a diagram for describing an example.

FIG. 10 is a diagram illustrating a computer that executes an inference program.

### DESCRIPTION OF EMBODIMENTS

Hereinafter, an embodiment of the present invention will be described in detail with reference to the drawings. The present invention is not limited to this embodiment. In the description of the drawings, the same portions are denoted by the same reference numerals.

### [Outline of Inference Device]

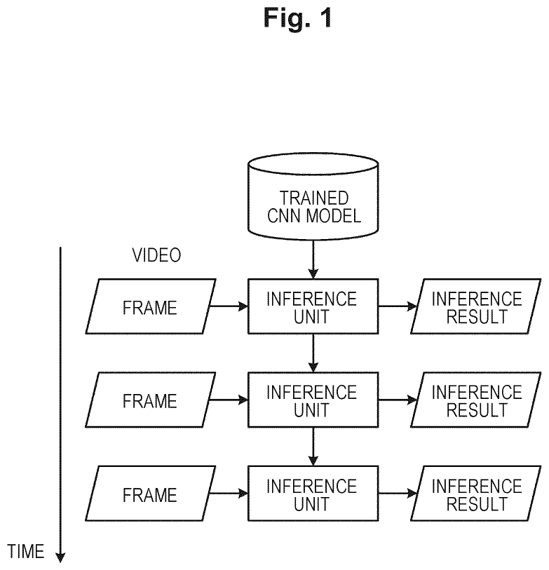

FIGS. 1 to 3 are diagrams for describing an outline of an inference device. As illustrated in FIG. 1, in a case where a video is analyzed by using a CNN to perform image recognition or object detection, each frame of the video is input to an inference unit using a trained CNN model, and an inference process is continuously performed to obtain an inference result.

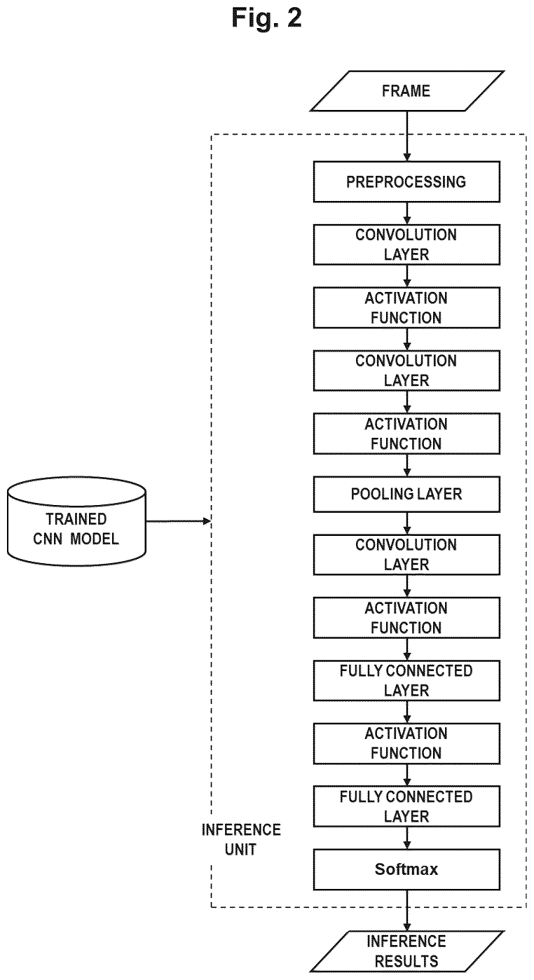

Here, as illustrated in FIG. 2, the inference unit using the trained CNN model includes a plurality of layers including a convolution layer, and each layer sequentially converts each frame of the input video by using an activation function. As described above, in general, the CNN model has a configuration in which a convolution layer and an activation function are stacked. A fully connected layer is a kind of convolution layer as will be described later.

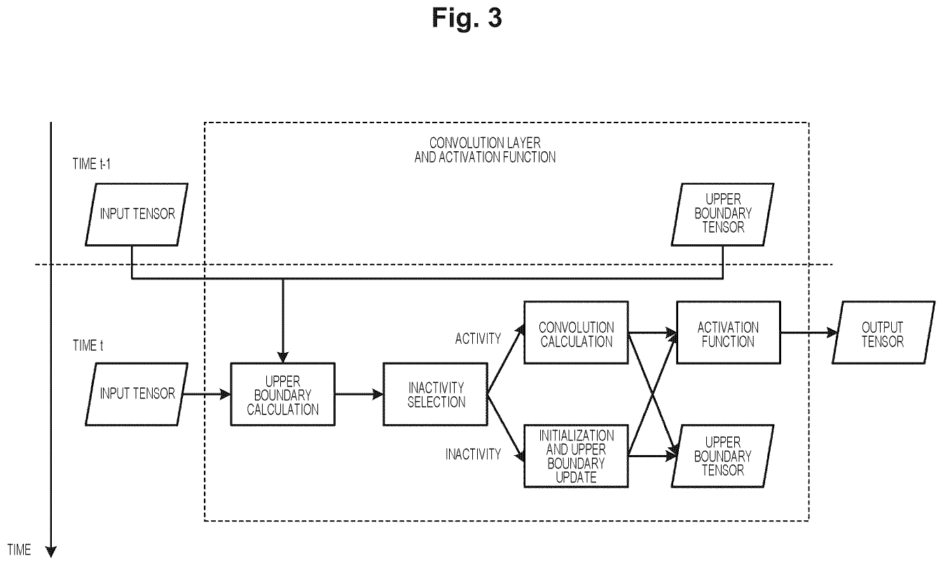

Specifically, as illustrated in FIG. 3, in each convolution layer, when an input tensor is input, an output tensor is output after an activation function is applied. The inference device according to the present embodiment executes an inference process that will be described later by using an input tensor and an upper boundary tensor one time ago in addition to a general convolution layer, and thus it is possible to suppress deterioration in accuracy and reduce a calculation cost.

Here, the upper boundary tensor is a tensor that holds a value of an upper boundary that can be taken by each output element. In the inference device of the present embodiment, the upper boundary tensor is held as an internal state in order to use the upper boundary tensor for calculation one time later.

The inference device selects an output that is always inactive in consideration of an additional input such as an activation function or a bias term. Here, the term “inactive” means that there is an input in a section in which an output is a constant in the domain of the activation function. For example, a rectified linear unit (ReLU) that is a general activation function is defined as the following Expression (1).

$$\begin{matrix}[ Math . 1 ] & \\ Re LU ( x ) = \{ \begin{matrix}x & ( x > 0 ) \\ 0 & ( x \leq 0 )\end{matrix} & ( 1 )\end{matrix}$$

Here, in the section of x≤0, an output is a constant of 0 and inactive. The inference device of the present embodiment omits calculation in a convolution layer for the output that becomes inactive as described above, and thus reduces the calculation cost in the convolution layer including a large number of product-sum operations.

Specifically, in the inactive case, the inference device writes the constant of the inactive section to the output tensor, and writes the calculated upper boundary value to the upper boundary tensor. In a case where there is a possibility of activity, calculation using the activation function is performed in the convolution layer, and the calculated upper boundary value is written to the upper boundary tensor, and a value after applying the activation function is written to the output tensor.

In the following description, the number of input channels is C, the number of output channels is K, a size of an input image is H×W, and a size of a convolution kernel is R×S. In this case, each element Y_{k,i,j} of the output tensor of the convolution layer of padding of 0 and stride of 1 is defined by the following Expression (2).

$$\begin{matrix}[ Math . 2 ] & \\ {Y}_{k , i , j} = {\sum }_{c = 0}^{C - 1} {\sum }_{r = 0}^{R - 1} {\sum }_{s = 0}^{S - 1} {𝒳}_{c , i + r , j + s} {𝒲}_{k , c , r , s} = {x}_{( i , j )} \cdot {w}_{( k )} , & ( 2 )\end{matrix}$$

Here, input tensor [symbol] ∈ [symbol] weight tensor of convolution layer [symbol] ∈

[symbol]

Here, x_{(i,j)} and w₍ₖ₎ are vectors in which the number of elements obtained by expanding the sum is CRS, as shown in the following Expressions (3) and (4).

$$\begin{matrix}[ Math . 3 ] & \\ {x}_{( i , j )} = {[ {𝒳}_{0 , i , j} , {𝒳}_{0 , i , j + 1} , … , {𝒳}_{C - 1 , i + R - 1 , j + S - 1} ]}^{T} & ( 3 )\end{matrix}$$

$$\begin{matrix}[ Math . 4 ] & \\ {w}_{( k )} = {[ {𝒲}_{k , 0 , 0 , 0} , {𝒲}_{k , 0 , 0 , 1 ,} , … , {𝒲}_{k , C - 1 , R - 1 , S - 1} ]}^{T} & ( 4 )\end{matrix}$$

The expansion into the vectors shown in the above Expressions (3) and (4) is generally called im2col. As described above, the convolution layer calculates the local features of the input by the size R×S of the convolution kernel.

In general, R=3 and S=3, but if R=H and S=W, calculation is performed by using all input tensors, which is equivalent to a fully connected layer. A padding and a stride are parameters for designating the handling of a boundary of an input image and an interval of moving a convolution kernel, and thus, selection of x_{(i,j)} from the element X changes.

A typical set of the convolution layer and the activation function is expressed by an element Z_{k,i,j} after applying the activation function as shown in the following Expression (5).

$$\begin{matrix}[ Math . 5 ] & \\ {Z}_{k , i , j} = Re LU ( {Y}_{k , i , j} + {b}_{k} ) , & ( 5 )\end{matrix}$$

Here, bₖ is a bias term added after calculation in the convolution layer. With a frame number as t, x_{(i,j)}^{(t)} indicates a value in a case where a frame at the current time is processed, and x_{(i,j)}^{(t-1)} indicates a value in a case where a frame one time ago is processed.

### [Configuration of Inference Device]

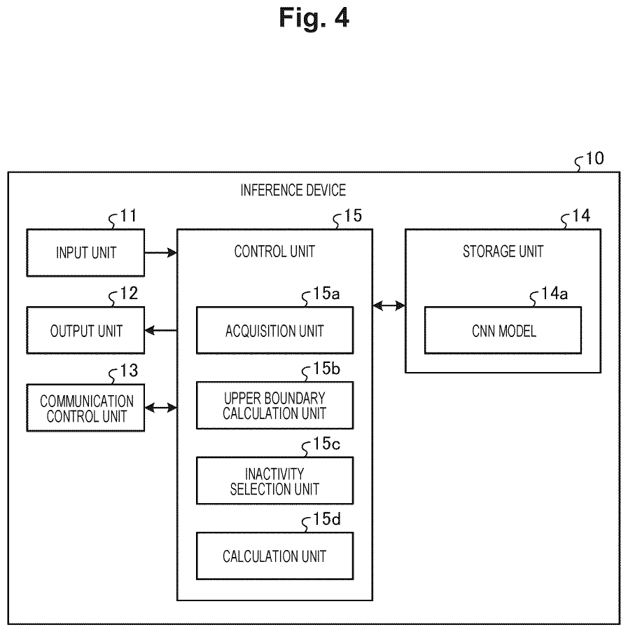

FIG. 4 is a schematic diagram exemplifying a schematic configuration of the inference device. As exemplified in FIG. 4, an inference device 10 is realized by a general-purpose computer such as a personal computer, and includes an input unit 11, an output unit 12, a communication control unit 13, a storage unit 14, and a control unit 15.

The input unit 11 is realized by using an input device such as a keyboard or a mouse, and inputs various types of instruction information such as processing start to the control unit 15 in response to an input operation of an operator. The output unit 12 is realized by a display device such as a liquid crystal display, a printing device such as a printer, or the like.

The communication control unit 13 is realized by a network interface card (NIC) or the like and controls communication between an external device such as a server and the control unit 15 via a network. For example, the communication control unit 13 controls communication between the control unit 15 and a management device or the like that manages video data that is an inference target.

The storage unit 14 is realized by a semiconductor memory element such as a random access memory (RAM) or a flash memory, or a storage device such as a hard disk or an optical disc. In the storage unit 14, a processing program for operating the inference device 10, data to be used during execution of the processing program, and the like are stored in advance or temporarily stored each time processing is performed. For example, the storage unit 14 stores a CNN model 14a and the like used for an inference process that will be described later. The storage unit 14 may be configured to communicate with the control unit 15 via the communication control unit 13.

The control unit 15 is realized by using a central processing unit (CPU) or the like, and executes a processing program stored in a memory. Consequently, as illustrated in FIG. 4, the control unit 15 functions as an acquisition unit 15a, an upper boundary calculation unit 15b, an inactivity selection unit 15c, and a calculation unit 15d. Each or some of these functional units may be provided in different hardware. The control unit 15 may include other functional units. For example, the control unit 15 may include a learning unit that will be described later.

The acquisition unit 15a receives input of frames of a video in time series. For example, the acquisition unit 15a acquires data to be used for an inference process that will be described later via the input unit 11 or the communication control unit 13. The acquisition unit 15a may store the acquired data in the storage unit 14. The acquisition unit 15a may transfer such information to the upper boundary calculation unit 15b described below instead of storing the information in the storage unit 14.

In a case where a plurality of layers forming the CNN model 14a sequentially converts the frames of the video input in time series by using the activation function, the upper boundary calculation unit 15b calculates an upper boundary of an output value of each layer by using the current input value of each layer and an input value and an output value one time ago.

The inactivity selection unit 15c uses the upper boundary to select an inactive portion that does not change according to an input from among the outputs of the activation functions of the respective layers.

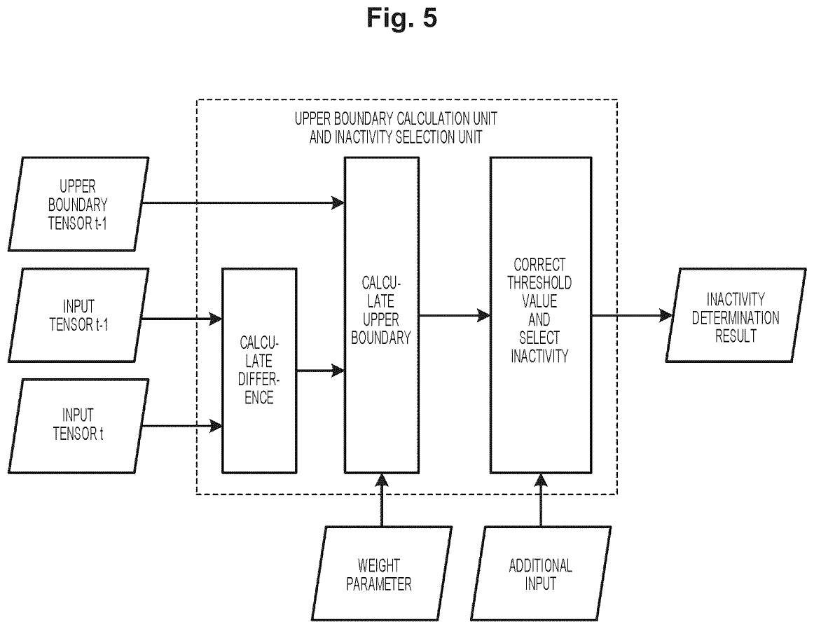

Here, FIG. 5 is a diagram for describing processes of the upper boundary calculation unit and the inactivity selection unit. As illustrated in FIG. 5, first, the upper boundary calculation unit 15b calculates a difference vector between an input tensor X^{(t)} at the current time and the input tensor X^{(t-1)} one time ago. The difference vector is expressed by the following Expression (6).

$${d}_{( i , j )}^{( t )} = {x}_{( i , j )}^{( t )} - {x}_{( i , j )}^{( t - 1 )} \qquad ( 6 )$$

Next, the upper boundary calculation unit 15b obtains an upper boundary of Y^{(t)} by using an upper boundary tensor one time ago and a weight tensor of a convolution layer as expressed by the following Expression (7).

$$\begin{matrix}[ Math . 7 ] & \\ Upper boundary of {Y}_{k , i , l}^{( t )} {\overline{Y}}_{k , i , j}^{( t )} = ‖ {d}_{( i , j )}^{( t )} ‖ ‖ {w}_{( k )} ‖ + {\overline{Y}}_{k , i , j}^{( t - 1 )} . & ( 7 )\end{matrix}$$

Here, upper boundary tensor one time ago Y̅_{k,i,j}^{(t-1)}

Next, the inactivity selection unit 15c selects an inactive element in consideration of an additional input such as a bias term or an inactive section of an activation function. For example, the inactivity selection unit 15c selects an inactive portion by using an inactive section of a rectified linear unit (ReLU). That is, a determination expression of the inactive element expressed by the following Expression (8) is obtained in consideration of the inactive section x≤0 of the ReLU shown in the above Expression (5).

$$\begin{matrix}[ Math . 8 ] & \\ {\overline{Y}}_{k , i , j}^{( t )} + {b}_{k} \underline{<} 0 & ( 8 )\end{matrix}$$

The inactivity selection unit 15c outputs the success or failure of the inequality shown in the above Expression (8) as an inactivity determination result.

The description returns to FIG. 4. The calculation unit 15d calculates an approximate value of an output value of the CNN model 14a by using the upper boundary, the inactive portion, and a portion of the activation function excluding a portion corresponding to the inactive portion. Specifically, the calculation unit 15d calculates, for each layer, an approximate value of an output value of the CNN model 14a by using a value of the upper boundary, a value of the inactive portion, and an output value of each layer calculated for a portion having a possibility of activity other than the portion corresponding to the inactive portion in the activation function.

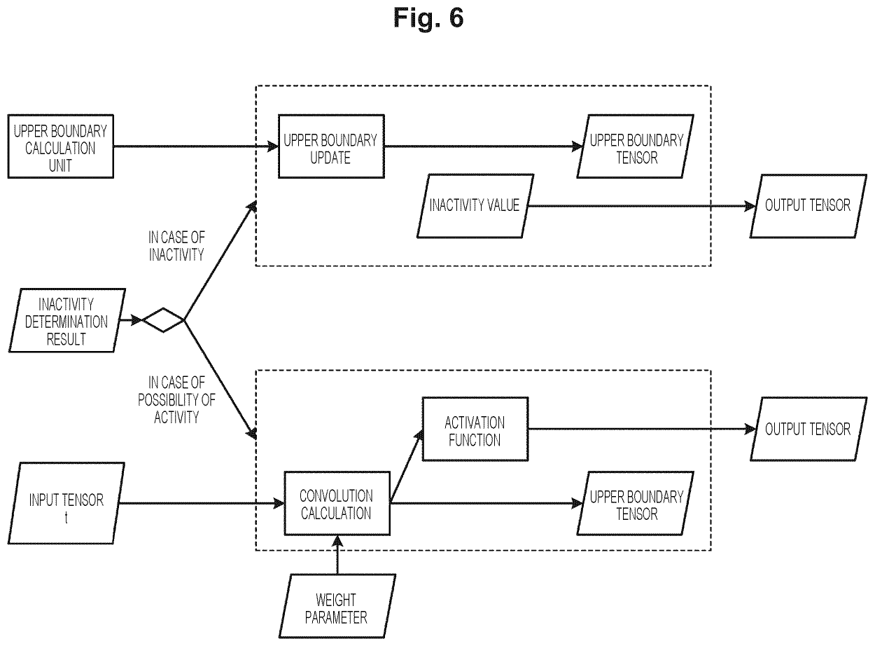

Here, FIG. 6 is a diagram for describing a process of the calculation unit. As illustrated in FIG. 6, the process of the calculation unit 15d is roughly divided into two according to an inactivity determination result in the inactivity selection unit 15c. First, in a case where the inactivity selection unit 15c determines inactivity, the calculation unit 15d writes an inactive value (for example, 0 in a case of the ReLU) to the output tensor. In this case, the calculation unit 15d writes and updates the upper boundary value calculated by the upper boundary calculation unit 15b by using the above Expression (7) to the upper boundary tensor.

In a case where the inactivity selection unit 15c determines no inactivity, that is, in a case where there is a possibility of activity, the calculation unit 15d calculates a value expressed by the following Expression (9), and writes a value to which a bias term is added and then the activation function is applied, to the output tensor. In this case, the calculation unit 15d writes and updates a value expressed by the following Expression (10) to the upper boundary tensor.

$$\begin{matrix}[ Math . 9 ] & \\ {Y}_{k , i , j}^{( t )} = {x}_{( i , j )}^{( t )} \cdot {w}_{( k )}^{( t )} & ( 9 )\end{matrix}$$

$$\begin{matrix}[ Math . 10 ] & \\ {\overline{Y}}_{k , i , j}^{( t )} = {Y}_{k , i , j}^{( t )} & ( 10 )\end{matrix}$$

Here, (i,j) is fixed, and a reduction ratio of the calculation cost is considered for K output elements. An amount of calculation in a normal convolution layer is represented as O (KCRS). In the case where a proportion at which the above Expression (8) is established among the K output elements is α, a calculation amount in a case where calculation for an inactive portion is omitted can be expressed as O (K(1-α) CRS). Since inputs necessary for the processes of the upper boundary calculation unit 15b and the inactivity selection unit 15c for the frame t are known constants except for the difference vector expressed by the above Expression (6), a calculation amount can be expressed as O (CRS). Therefore, a calculation amount necessary for the inference process of the inference device 10 of the present embodiment can be expressed as O((K(1-α)+1) CRS).

In general, since K≥64, it can be seen that the calculation cost is reduced to be approximately proportional to (1-a) according to the inference process of the inference device 10 of the present embodiment. α depends on a difference between the frames shown in the above Expression (6), but since a is a high value in a video, particularly a video captured by a fixed camera such as a monitoring camera, the inference process of the present embodiment effectively reduces the calculation cost.

As described above, the inference device 10 omits calculation in a convolution layer for an inactive output, and thus reduces the calculation cost in the convolution layer including a large number of product-sum operations. Therefore, the inference device 10 can obtain an approximate value of the output value of the inference unit using the CNN model 14a by reducing the calculation cost without deterioration in the accuracy.

The calculation unit 15d can also train the CNN model 14a by using training data. In this case, in the inference device 10, the control unit 15 may further include a learning unit. The learning unit trains the CNN model 14a by using an approximate value of an output value of the CNN model 14a calculated by the calculation unit 15d by using the training data. Consequently, it is possible to generate the highly accurate CNN model 14a while deleting the calculation cost for learning using the training data.

The CNN model 14a is not limited to a case where a calculation result of the convolution layer is directly input to the activation function. For example, there is a case where a normalization process called batch normalization is performed, or there is a case where a configuration called shortcut connection is used in which an addition process of output values of previous layers is performed after calculation of a convolution layer and before application of an activation function. When such processing is f (x), the inference process of the present embodiment can be applied in a case where the following Expression (11) is established for any x and y. In this case, the inactivity selection unit 15c may use the following Expression (12) as an inactive element determination expression instead of the above Expression (8).

$$\begin{matrix}[ Math . 11 ] & \\ x < y ⇔ f ( x ) < f ( y ) & ( 11 )\end{matrix}$$

$$\begin{matrix}[ Math . 12 ] & \\ f ( {\overline{Y}}_{k , i , j}^{( t )} + {b}_{k} ) \underline{<} 0 & ( 12 )\end{matrix}$$

In a case where x is multiplied by a negative value in f (x), a direction of the inequality sign in the above Expression (12) changes, but the signs of the weight tensor and bₖ may be inverted in advance.

The inference device 10 may process the calculation of the convolution layer in parallel. For example, elements of the output tensor are distributed to processors. In this case, it is desirable that the elements are distributed such that processing on the elements of the output tensor sharing an input region to be used is performed by the same processor. The input region is easily stored in a cache in which memory access is fast, and a processing speed can be expected to be increased. Specifically, for example, both X_{(i,j)} and w₍ₖ₎ are divided and distributed in a two-dimensional tile form to be stored in the cache.

On the other hand, in the present embodiment, since an element that is not inactive but may be active is dynamically determined according to an input, it is difficult to divide elements into a two-dimensional tile form while equalizing the number of elements processed by each processor. Therefore, in order to apply the inference process of the present embodiment, elements to be calculated are unitarily arranged and divided. In this case, although the number of elements processed by each processor is equal, only w₍ₖ₎ is stored in the cache and reused, and x_{(i,j)} is not reused. Therefore, in a case where most of the elements of the output tensor cannot be omitted from calculation, it may be difficult to improve efficiency through parallelization of processes.

Therefore, focusing on the property of the output value of the convolution layer, the output tensor is divided into a portion to which the inference process of the present embodiment is applied and a portion to which the inference process is not applied, and deterioration in efficiency due to parallelization of processes is reduced. This is because when the output value of the convolution layer is observed for each channel, there is a bias in a ratio of inactivation due to the activation function. That is, depending on channels, most elements may be inactive or, conversely, most elements may be active.

Therefore, the inference process of the present embodiment is applied only to a channel in which a ratio of inactive elements is equal to or more than a predetermined threshold value, and general parallel processing is performed on other channels without applying the inference process of the present embodiment. That is, in a case where a proportion of a portion corresponding to the inactive portion to the whole of the activation function of each layer is equal to or more than a predetermined threshold value, the calculation unit 15d calculates an approximate value of the output value of the CNN model 14a by using the upper boundary, the inactive portion, and a portion obtained by excluding the inactive portion among outputs of the activation function. Consequently, the inference process of the present embodiment can be applied only to a channel that can be speeded up as compared with general parallel processing, and thus speeding up can be achieved for all convolution layers.

In an intermediate layer, since there are many cases where outputs of a convolution layer and an activation function are input tensors of the next convolution layer, similarly to the above-described output tensor, the input tensor may also be divided into a channel having many inactive elements and a channel having few inactive elements. In particular, in a case where the activation function is the ReLU, since an inactive value is 0, a channel having many inactive elements, that is, a channel having few non-zero elements only needs to add a value to the input tensor of the next convolution layer only for output values to which the non-zero elements contribute.

### [Inference Process]

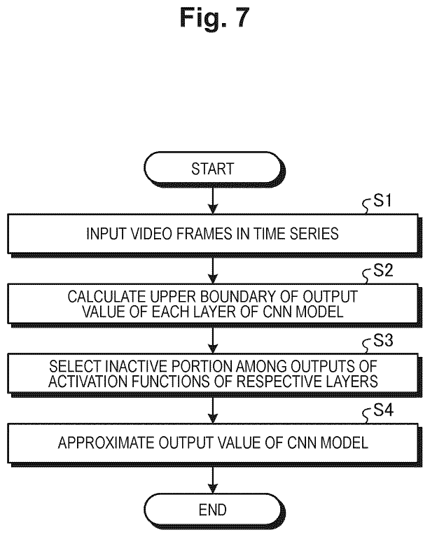

Next, an inference process performed by the inference device 10 according to the present embodiment will be described with reference to FIG. 7. FIG. 7 is a flowchart illustrating an inference process procedure. The flowchart of FIG. 7 is started, for example, at a timing at which an operation for giving an instruction for starting the inference process is input.

First, the acquisition unit 15a receives input of frames of a video in time series (step S1). Next, the upper boundary calculation unit 15b calculates upper boundaries of output values of the respective layers by using the current input values of the plurality of layers forming the CNN model 14a and input values and output values one time ago (step S2).

The inactivity selection unit 15c selects an inactive portion that does not change according to the input from among the outputs of the activation functions of the respective layers by using the calculated upper boundaries (step S3).

The calculation unit 15d calculates an approximate value of an output value of the CNN model 14a by using the upper boundary, the inactive portion, and a portion of the activation function excluding the portion corresponding to the inactive portion (step S4).

Specifically, for each layer, the calculation unit 15d calculates an approximate value of the output value of the CNN model 14a by using a value of the upper boundary, a value of the inactive portion, and an output value of each layer calculated for the portion having a possibility of activity, excluding the portion corresponding to the inactive portion in the activation function. Consequently, a series of inference processes are ended.

As described above, in the inference device 10, in a case where the plurality of layers forming the CNN model 14a sequentially convert the frames of the video input in time series by using the activation function, the upper boundary calculation unit 15b calculates the upper boundary of the output value of each layer by using the current input value of each layer and the input value and the output value one time ago. The inactivity selection unit 15c selects an inactive portion that does not change according to the input from among the outputs of the activation functions of the respective layers by using the upper boundary. The calculation unit 15d calculates an approximate value of the output value of the CNN model 14a by using the upper boundary, the inactive portion, and the portion having the possibility of activity excluding the portion corresponding to the inactive portion in the activation function.

As described above, the inference device 10 omits calculation in a convolution layer for an inactive output, and thus reduces the calculation cost in the convolution layer including a large number of product-sum operations. Consequently, the inference device 10 can reduce the calculation cost by suppressing deterioration in the accuracy in the inference process using the deep learning model based on CNN.

The inactivity selection unit selects an inactive portion by using the inactive section of an ReLU. Consequently, a value of the inactive portion becomes zero, and the calculation cost can be further reduced.

In a case where a proportion of the portion corresponding to the inactive portion to the whole of the activation function of each layer is equal to or more than the predetermined threshold value, the calculation unit 15d calculates an approximate value of the output value of the CNN model 14a by using the upper boundary, the inactive portion, and a portion obtained by excluding the inactive portion among outputs of the activation function. Consequently, for example, the inference process of the present embodiment is applied only to a channel that can be speeded up as compared with the parallel processing, and the parallel processing is applied to other channels, so that speeding up can be achieved for all convolution layers.

The learning unit trains the CNN model 14a by using an approximate value of the output value of the CNN model 14a calculated by the calculation unit 15d by using the training data. Consequently, it is possible to generate the highly accurate CNN model 14a while deleting the calculation cost for learning using the training data.

### EXAMPLE

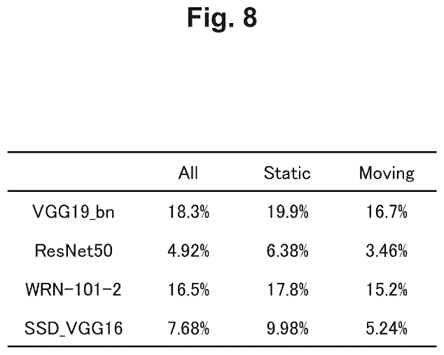

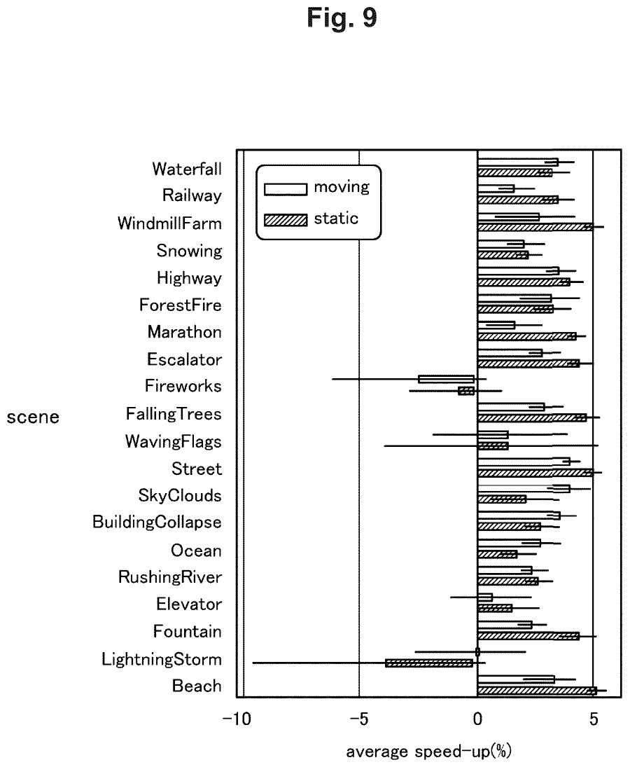

FIGS. 8 and 9 are diagrams for describing examples of the present invention. FIGS. 8 and 9 illustrate a reduction ratio of the number of operations due to the inference process of the present invention described above and a speed-up ratio of the execution time on the GPU by using a generally available trained CNN model 14a.

Here, the CNN model 14a includes VGG 19_bn, ResNet 50, and Wide ResNet (WRN)-101-2 acquired from torchvision, and SSD_VGG 16 acquired from gluoncy. A YUP++data set including 20 categories of video scenes was used as an input video. The execution time was measured by using Jetson Nano and compared with a general convolutional computation library.

Specifically, FIG. 8 illustrates an average reduction ratio of the number of operations when all videos (All) in the YUP++data set, videos (Static) from a fixed camera, and videos (Moving) from a dynamic camera are input. FIG. 9 exemplifies an average speed-up ratio at the time of parallel processing on the GPU for each video scene in a case where VGG 19 bn is used as the CNN model 14a.

Consequently, it has been confirmed that the mean square error between a vector output by the original processing of the CNN model 14a and a vector output by the inference process of the present invention is a sufficiently small error of about 1E-12.

### [Program]

It is also possible to produce a program that describes, in a computer executable language, the processing executed by the inference device 10 according to the above embodiment. As an embodiment, the inference device 10 can be implemented by installing an inference program for executing the inference process described above as package software or online software in a desired computer. For example, by causing an information processing device to execute the inference program described above, it is possible to cause the information processing device to function as the inference device 10. The information processing device also includes a mobile communication terminal such as a smartphone, a mobile phone, and a personal handyphone system (PHS), a slate terminal such as a personal digital assistant (PDA), and the like. The functions of the inference device 10 may be implemented in a cloud server.

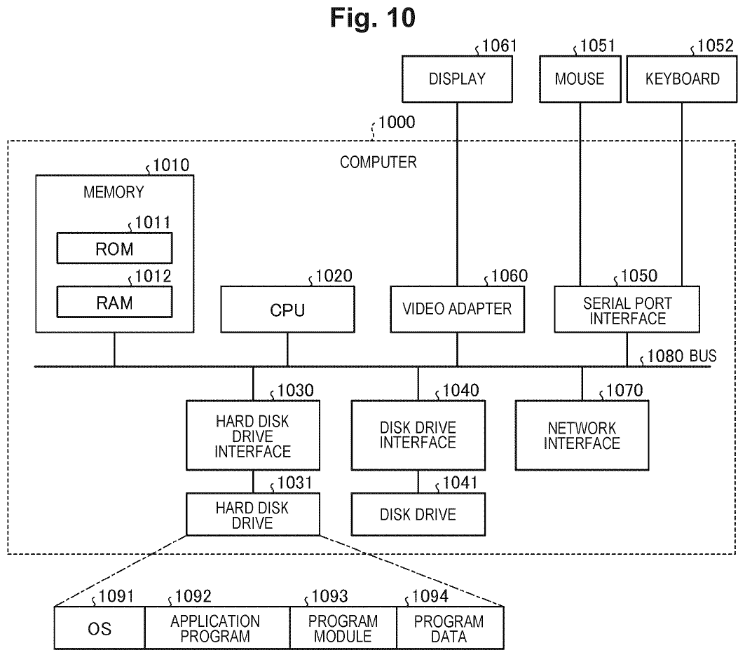

FIG. 10 is a diagram illustrating an example of a computer that executes an inference program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. All of the information described in the above embodiment is stored in the hard disk drive 1031 or the memory 1010, for example.

The inference program is stored in the hard disk drive 1031 as the program module 1093 in which commands to be executed by the computer 1000, for example, are described. Specifically, the program module 1093 in which each process executed by the inference device 10 described in the above embodiment is described is stored in the hard disk drive 1031.

Data used for information processing performed by the inference program is stored as the program data 1094 in the hard disk drive 1031, for example. The CPU 1020 reads, into the RAM 1012, the program module 1093 and the program data 1094 stored in the hard disk drive 1031 as needed and executes each procedure described above.

The program module 1093 and the program data 1094 related to the inference program are not limited to being stored in the hard disk drive 1031, and may be stored in, for example, a removable storage medium and read by the CPU 1020 via the disk drive 1041 or the like. Alternatively, the program module 1093 and the program data 1094 related to the inference program may be stored in another computer connected via a network such as a local area network (LAN) or a wide area network (WAN) and may be read by the CPU 1020 via the network interface 1070.

Although the embodiments to which the invention made by the present inventor is applied have been described above, the present invention is not limited by the description and the drawings forming a part of the disclosure of the present invention according to the present embodiments. In other words, other embodiments, examples, operation techniques, and the like made by those skilled in the art and the like on the basis of the present embodiment are all included in the scope of the present invention.

### REFERENCE SIGNS LIST

10 Inference device
11 Input unit
12 Output unit
13 Communication control unit
14 Storage unit
14a CNN model
15 Control unit
15a Acquisition unit
15b Upper boundary calculation unit
15c Inactivity selection unit
15d Calculation unit

1. An inference device comprising:
upper boundary calculation circuitry that calculates an upper boundary of an output value of each layer by using a current input value of each layer and an input value and an output value one time ago in a case where a plurality of layers forming a model sequentially convert frames of a video input in time series by using an activation function;
inactivity selection circuitry that uses the upper boundary to select an inactive portion that does not change according to an input from among outputs of activation functions of the respective layers; and
calculation circuitry that calculates an approximate value of an output value of the model by using the upper boundary, the inactive portion, and a portion of the activation function excluding a portion corresponding to the inactive portion.

2. The inference device according to claim 1, wherein:
the inactivity selection circuitry selects the inactive portion by using an inactive section of rectified linear circuitry (ReLU).

3. The inference device according to claim 1, wherein:
the calculation circuitry calculates the approximate value of the output value of the model by using the upper boundary, the inactive portion, and the portion of the activation function excluding the portion corresponding to the inactive portion in a case where a proportion of the inactive portion to all of the outputs of the activation functions of the respective layers is equal to or more than a predetermined threshold value.

4. The inference device according to claim 1, further comprising:
a learning circuitry that trains the model by using training data and the approximate value that is calculated by the calculation circuitry.

5. An inference method, comprising:
calculating an upper boundary of an output value of each layer by using a current input value of each layer and an input value and an output value one time ago in a case where a plurality of layers forming a model sequentially convert frames of a video input in time series by using an activation function;
using the upper boundary to select an inactive portion that does not change according to an input from among outputs of activation functions of the respective layers; and
calculating an approximate value of an output value of the model by using the upper boundary, the inactive portion, and a portion of the activation function excluding a portion corresponding to the inactive portion.

6. An inference program for causing a computer to function as the inference device according to claim 1.

7. A non-transitory computer readable medium including a computer program which when executed causes one or more processors to perform the method of claim 5.
